(19) United States
(12) Patent Application Publication
(10) Pub. No.: US 2020/0161825 A1
(43) Pub. Date: May 21, 2020

(54) LIQUID COOLED LASER OPTICAL BENCH FOR THERMAL POINTING STABILITY

(71) Applicant: BAE SYSTEMS Information and Electronic Systems Integration Inc., Nashua, NH (US)

(72) Inventors: James P. ZONA, Merrimack, NH (US); Gerard J. PELLETIER, Amherst, NH (US); David E. THOMPSON, Nashua, NH (US)

(73) Assignee: BAE SYSTEMS Information and Electronic Systems Integration Inc., Nashua, NH (US)

(21) Appl. No.: 16/196,006

(22) Filed: Nov. 20, 2018

(51) Int. Cl. H01S 3/04; H01S 3/042; F28F 3/12; F28F 27/00

(52) U.S. Cl. CPC H01S 3/0407; H01S 3/042; F28F 2250/08; F28F 27/00; F28F 3/12

(57) ABSTRACT

A system and method for liquid cooling an optical bench to provide for thermal stability. The liquid cooled bench may optionally be chilled with a cold plate. In some cases, individual components which generate excess heat contain circulating fluid connected to a network of channels within the optical bench to provide for cooling and even distribution of liquid flow and temperature.

### STATEMENT OF GOVERNMENT INTEREST

This disclosure was made with United States Government support under Contract No. 14-C-8215 awarded by a Classified Agency. The United States Government has certain rights in this disclosure.

### FIELD OF THE DISCLOSURE

The present disclosure relates to precision optic systems and more particularly to liquid cooled optical bench for thermal pointing stability.

### BACKGROUND OF THE DISCLOSURE

Currently, precision machined optical benches attempt to minimize the heat loads on the bench as much as possible. Small heat loads are distributed to minimize thermal gradients. In other applications, on thicker benches, heat loads are placed on opposite sides of the bench to control bending distortion. In some situations, high heat loads cannot be remoted and need to be on the bench. In some instances, cooling lines are routed to the heat sources independent of the bench.

Wherefore it is an object of the present disclosure to overcome the above-mentioned shortcomings and drawbacks associated with the conventional optical systems. The liquid cooled bench of the present disclosure not only minimizes gradients, but also provides integrated coolant paths to specific sources, simplifying assembly and reducing risk of hose and fitting leaks.

### SUMMARY OF THE DISCLOSURE

One aspect of the present disclosure is an active optical system comprising very high heat density sources on a precision optical bench. The bench is a machined aluminum assembly with integral coolant paths to distribute fluid and minimize thermal gradients in all three directions; across and through the bench.

Another aspect of the present disclosure is a liquid cooled bench, comprising: a bench having machined fluid channels therein; a pump for controlling and adjusting a flow of a coolant within the fluid channels; one or more liquid cooled optical mounts for utilizing coolant from the fluid channels in the bench; one or more temperature sensors for monitoring thermal gradients across the bench; and one or more pressure sensors for monitoring pressure gradients across the bench.

One embodiment of the liquid cooled bench is wherein the fluid channels are parallel. In certain embodiments the liquid cooled bench further comprises one or more check valves.

Another embodiment of the liquid cooled bench is wherein a 2.5 degree or less temperature gradient is maintained. In some cases, the coolant is a polyalphaolefin.

Yet another embodiment of the liquid cooled bench further comprises one or more quick disconnect fittings between the fluid channels and the liquid cooled optical mounts.

In certain embodiments, the liquid cooled bench further comprises one or more leak detectors.

Still yet another embodiment of the liquid cooled bench is wherein a 3.5 psi pressure differential or less is maintained. In one embodiment, the optical mounts are for laser rods and provide for thermal pointing stability of an optical system.

Yet another aspect of the present disclosure is a method of designing an optical cooling bench, comprising: a bench having machined fluid channels therein; a pump for controlling and adjusting a flow of a coolant within the fluid channels; one or more liquid cooled optical mounts for utilizing coolant from the bench; one or more temperature sensors for monitoring thermal gradients; and one or more pressure sensors for monitoring pressure gradients; developing a beamline and identifying all optics that are sensitive to small movements; optimizing the beamline to limit the number of sensitive optics; determining thermal loads on the bench and evaluating if those loads can be isolated from the bench; performing a first order thermal analysis to establish hot spots and gradients; routing fluid paths to address highest heat loads and/or highly sensitive components and subassemblies; and documenting liquid coolant parameters including flow rate, temperature, and pressure.

Still yet another aspect of the present disclosure is a method of liquid cooling optical components; comprising: providing a liquid cooled bench, comprising: machined fluid channels within the bench; a pump fluidly connected to the fluid channels; one or more liquid cooled optical mounts fluidly connected to the fluid channels; one or more temperature sensors; and one or more pressure sensors; circulating a coolant through the bench and the one or more optical mounts using the pump; controlling and adjusting a flow of a coolant within the fluid channels and the optical mounts using the pump; monitoring thermal gradients across the bench using the one or more temperature sensors; and monitoring pressure gradients across the bench using the one or more pressure sensors.

One embodiment of the method of liquid cooling optical components is wherein the fluid channels are parallel. Some embodiments of the method of liquid cooling optical components further comprise one or more check valves.

Another embodiment of the method of liquid cooling optical components is wherein a 2.5 degree or less temperature gradient is maintained. In some cases, the coolant is a polyalphaolefin.

Yet another embodiment of the method of liquid cooling optical components further comprises one or more quick disconnect fittings between the fluid channels and the liquid cooled optical mounts. In some cases, the method of liquid cooling optical components further comprises one or more leak detectors.

Still yet another embodiment of the method of liquid cooling optical components is wherein a 3.5 psi differential or less is maintained. In one embodiment, the optical mounts are used for laser rods and provide for thermal pointing stability of the optical components.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a diagrammatic view of one embodiment of the system of the present disclosure.

FIG. 2 shows a perspective view of one embodiment of the system of the present disclosure testing pressure differentials in the system.

FIG. 3 shows a perspective view of one embodiment of the system of the present disclosure testing flow patterns in the system.

FIG. 4 shows a plot of temperature across one embodiment of the system of the present disclosure.

FIG. 5 is a flow chart of one embodiment of a method according to the principles of the present disclosure.

### DETAILED DESCRIPTION OF THE DISCLOSURE

One embodiment of the system of the present disclosure provides for the elimination of waste heat from various components which can cause laser performance degradation due to mounting surface distortion and differences in the coefficients of thermal expansion for various materials. In some cases, the system also minimizes the effect of extreme ambient temperatures on the optical bench dimensional stability. In one embodiment, liquid cooling provides a compact method of cooling very high heat density sources. Channeling liquid to these sources also makes for a thermally efficient system eliminating high delta T conduction paths.

One embodiment of the present disclosure provides temperature controlled cooling liquid that specifically targets the high heat dissipating components. In some cases, the high heat dissipating components are laser rods. In one embodiment, the liquid is polyalphaolefin (PAO). The approach of the present disclosure also distributes the liquid across passive sections of the bench to normalize the temperature of the structure over military range thermal environments, typically −40° to +70° C.

Providing coolant directly to the heat sources using internal flow passages eliminates the need for external tubes and fittings which can be bulky and potential leak sources. Distribution of the fluid internal to the bench also thermally stabilizes the entire structure, minimizing distortion and misalignment of sensitive optical components and sub-assemblies. These distortions are known to degrade laser performance including power, beam quality, and pointing stability. Additionally, the use of internal fluid passages reduces cost by reducing part count and assembly time.

Certain embodiments of this design are applicable to any temperature sensitive or opto-mechanically stabilized assembly with precision dimensional stability and pointing requirements. These instruments include, but are not limited to, optical transmitters, receivers, and pointing systems. Extensive testing has been done to characterize the effect of thermal gradients on both main structures such as the optical bench as well as smaller optical sub-assemblies.

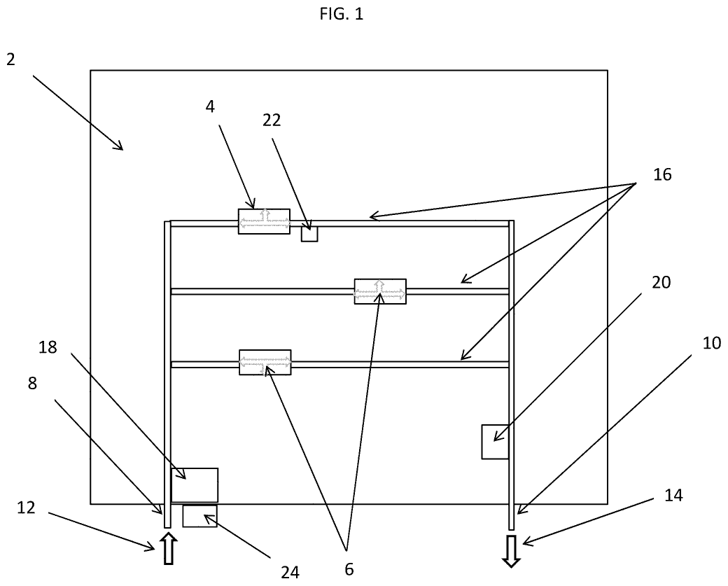

Referring to FIG. 1, a diagrammatic view of one embodiment of the system of the present disclosure is shown. More specifically, an optical bench 2 has one or more thermally sensitive components 4 mounted thereon. In one embodiment of the present disclosure, the components generate excess heat and require precision dimensional stability. In some cases, the components have high heat loads, operating at 100 s W of power. In one example, the components are laser rods. In one embodiment of the present disclosure, the one or more components comprise internal fluid channels 6 which are used to liquid cool the individual component. Each of the one or more components is connected to a fluid system of the optical bench. In one embodiment, there is an inlet 8 and an outlet 10 for the fluid system of the optical bench, such that cooler fluid 12 enters the inlet and warmer fluid 14 exits the outlet.

Still referring to FIG. 1, the components are fluidly connected to each other in parallel 16 in this embodiment. In certain embodiments, channels are drilled into the optical bench to provide a network of liquid pathways of the cooling liquid to circulate. A pump 18 is used to circulate the cooling fluid throughout the system. In certain embodiments, the pressure of the fluid is from about 15 pounds per square inch (PSI) to about 20 PSI and the flow of liquid is at about 1.7 gallons per minute (gpm). In certain embodiments, there are one or more pressure gauges 20 to measure the pressure of the system at one or more locations. In certain embodiments, there are one or more temperature gauges 22 to measure the temperature of the system at one or more locations. In certain embodiments, the bench is chilled using a cold plate. As noted here, in some cases, the sub-assemblies, or components comprise fluid channels for circulating the cooling liquid through the component and the bench. In this embodiment, there is a controller for controlling the fluid cooling system.

In certain embodiments of the system of the present disclosure, the flow control valves are designed and integrated to balance the flow between the three parallel paths. The paths needed to be parallel in order to deliver a consistent fluid temperature to each of the three laser rods. Laser performance is dependent on these components maintaining similar temperatures. Parallel paths were also chosen to minimize pressure loss through the bench.

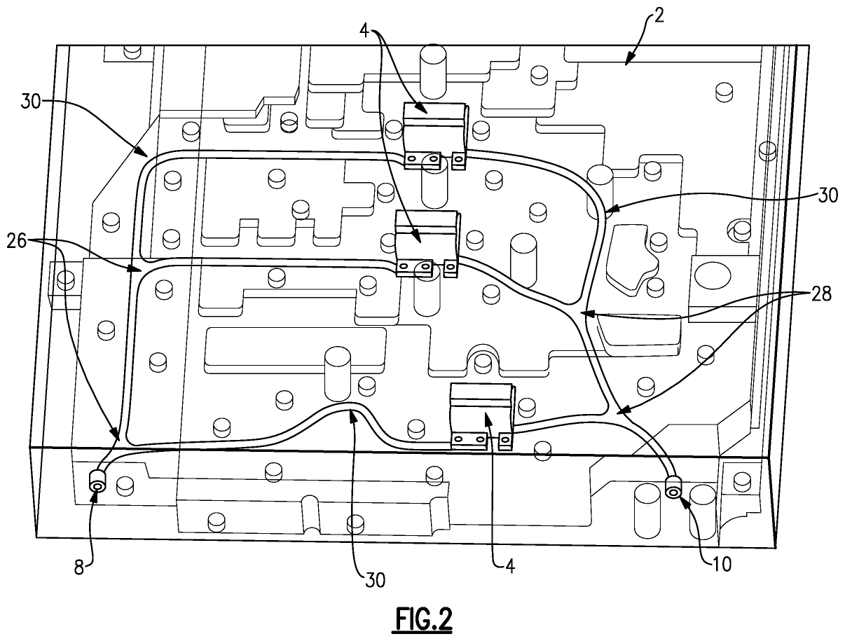

Referring to FIG. 2, a perspective view of one embodiment of the system of the present disclosure testing pressure differentials in the system is shown. More specifically, in certain embodiments channels are drilled into the optical bench to provide a network of liquid pathways of the cooling liquid to circulate. In one embodiment of the present disclosure, the one or more components 4 mounted on the bench 2 comprise internal fluid channels which are used to liquid cool the individual component. In some embodiments, tubing may be used and connected with fluid tight O-rings and the like. A series of channels intersect on the inflow 26 and the outflow 28 portions of the fluid system. The gradient is used to show the pressure distribution across the system. The path of the channels 30 can be made to accommodate the placement of heat generating components 4 and to avoid other component placement on the bench. In one embodiment, a 3.5 psi differential was allocated to the bench for initial trials. In one embodiment a 2 psi differential was achieved. In this application, pressure loss through the system was tightly controlled. The flow path geometry was developed to optimize heat transfer performance while minimizing pressure loss.

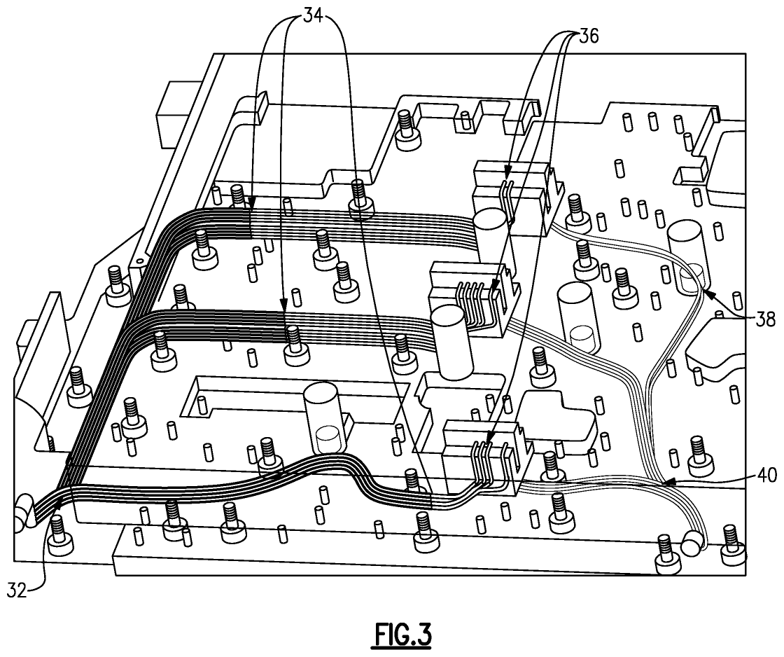

Referring to FIG. 3, a perspective view of one embodiment of the system of the present disclosure testing flow patterns in the system is shown. More specifically, the highest flow 32 was seen in the inlet region of the fluidic system. Flow began to decrease 34 as the channel length increased. Another drop in flow was seen as the cooling fluid circulated through the various components 36. As the fluid left the various components there was another drop in flow 38, followed by the lowest flow readings in the outlet region of the system. In certain embodiments, the flow trajectory of the liquid cooled bench showed inconsistent distribution of fluid to three laser rod mounts. In certain embodiments a flow control module is built into the liquid cooled bench to mitigate inconsistent flow distribution.

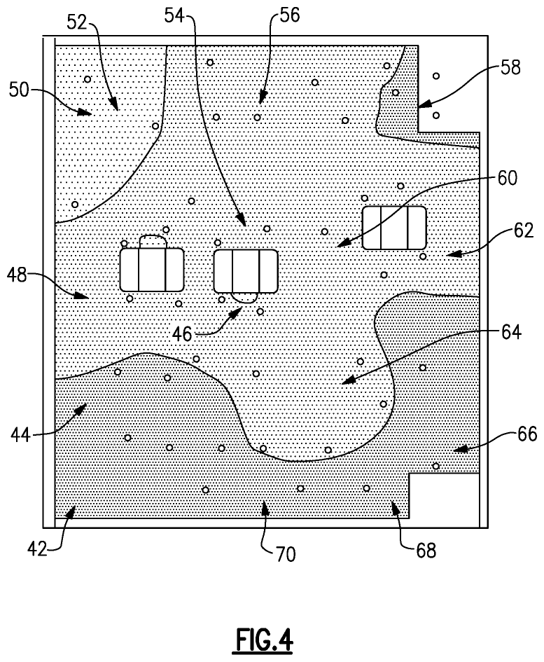

Referring to FIG. 4, a plot of temperature across one embodiment of the system of the present disclosure is shown. More specifically, this plot of temperature distribution shows the inlet region 68 and outlet region 58 in a different orientation from the previous figures. In this embodiment, the overall temperature distribution for the bench was within about 2.5 degrees Celsius. More particularly, going counter clockwise starting at the lower left the temperatures were 20.75° C. 42, 20.96° C. 44, 21.51° C. 46, 21.53° C. 48, 22.82° C. 50, 22.60° C. 52, 21.49° C. 54, 21.49° C. 56, 20.99° C. 58, 21.42° C. 60, 21.20° C. 62, 21.78° C. 64, 20.46° C. 66, 20.37° C. 68, and 20.65° C. 70. In certain embodiments of the system of the present disclosure a 2.5 degree max gradient is preferred.

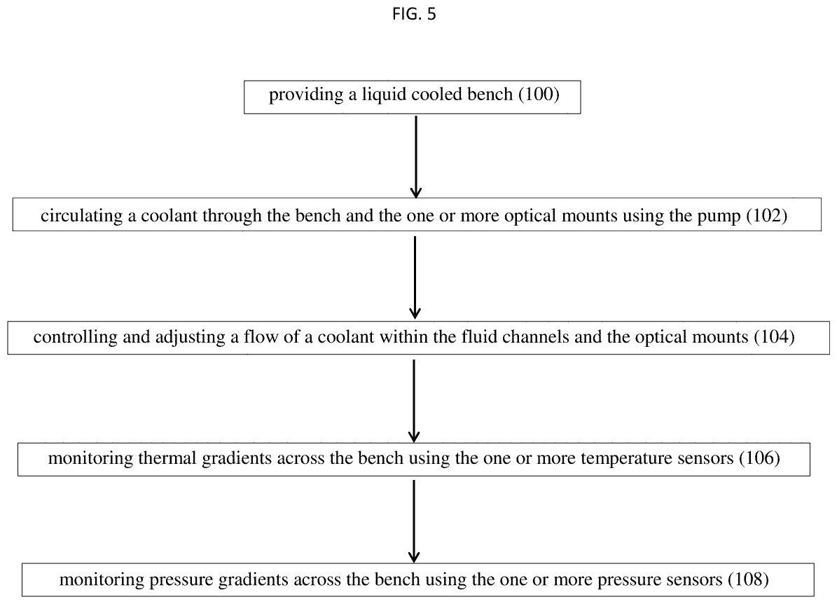

Referring to FIG. 5, a flow chart of one embodiment of a method according to the principles of the present disclosure is shown. More specifically, a method of liquid cooling optical components; comprises providing a liquid cooled bench, comprising: machined fluid channels within the bench; a pump fluidly connected to the fluid channels; one or more liquid cooled optical mounts fluidly connected to the fluid channels; one or more temperature sensors; and one or more pressure sensors 100. A coolant is circulated through the bench and the one or more optical mounts using the pump 102. A flow of the coolant within the fluid channels and the optical mounts is controlled and adjusted using the pump. In some cases, the pump is controlled manually or via control module on a computer 104. In some cases thresholds and limits for controlling and adjusting the parameters of the system are stored in memory or the like. Thermal gradients across the bench are monitored using the one or more temperature sensors 106 and pressure gradients across the bench are monitored using the one or more pressure sensors 108.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

1. A liquid cooled bench, comprising:
a bench having machined fluid channels therein;
a pump for controlling and adjusting a flow of a coolant within the fluid channels;
one or more liquid cooled optical mounts for utilizing the coolant from the fluid channels in the bench;
one or more temperature sensors for monitoring thermal gradients across the bench; and
one or more pressure sensors for monitoring pressure gradients across the bench.

2. The liquid cooled bench according to claim 1, wherein the fluid channels are parallel.

3. The liquid cooled bench according to claim 1, further comprising one or more check valves.

4. The liquid cooled bench according to claim 1, wherein a 2.5 degree or less temperature gradient is maintained.

5. The liquid cooled bench according to claim 1, wherein the coolant is a polyalphaolefin.

6. The liquid cooled bench according to claim 1, further comprising one or more quick disconnect fittings between the fluid channels and the one or more liquid cooled optical mounts.

7. The liquid cooled bench according to claim 1, further comprising one or more leak detectors.

8. The liquid cooled bench according to claim 1, wherein a 3.5 psi pressure differential or less is maintained.

9. The liquid cooled bench according to claim 1, wherein the one or more liquid cooled optical mounts are for laser rods and provide for thermal pointing stability of an optical system.

10. A method of designing an optical cooling bench, comprising:
a bench having machined fluid channels therein;
a pump for controlling and adjusting a flow of a coolant within the fluid channels;
one or more liquid cooled optical mounts for utilizing coolant from the bench;
one or more temperature sensors for monitoring thermal gradients; and
one or more pressure sensors for monitoring pressure gradients;
developing a beamline and identifying all optics that are sensitive to small movements;
optimizing the beamline to limit the number of sensitive optics;
determining thermal loads on the bench and evaluating if the thermal loads can be isolated from the bench;
performing a first order thermal analysis to establish hot spots and gradients;
routing fluid paths to address highest heat loads and/or highly sensitive components and subassemblies; and
documenting liquid coolant parameters including flow rate, temperature, and pressure.

11. A method of liquid cooling optical components; comprising:
providing a liquid cooled bench, comprising:
machined fluid channels within the bench;
a pump fluidly connected to the fluid channels;
one or more liquid cooled optical mounts fluidly connected to the fluid channels;
one or more temperature sensors; and
one or more pressure sensors;
circulating a coolant through the bench and the one or more liquid cooled optical mounts using the pump;
controlling and adjusting a flow of the coolant within the fluid channels and the one or more liquid cooled optical mounts using the pump;
monitoring thermal gradients across the bench using the one or more temperature sensors; and
monitoring pressure gradients across the bench using the one or more pressure sensors.

12. The method of liquid cooling optical components according to claim 11, wherein the fluid channels are parallel.

13. The method of liquid cooling optical components according to claim 11, further comprising one or more check valves.

14. The method of liquid cooling optical components according to claim 11, wherein a 2.5 degree or less temperature gradient is maintained.

15. The method of liquid cooling optical components according to claim 11, wherein the coolant is a polyalphaolefin.

16. The method of liquid cooling optical components according to claim 11, further comprising one or more quick disconnect fittings between the fluid channels and the one or more liquid cooled optical mounts.

17. The method of liquid cooling optical components according to claim 11, further comprising one or more leak detectors.

18. The method of liquid cooling optical components according to claim 11, wherein a 3.5 psi pressure differential or less is maintained.

19. The method of liquid cooling optical components according to claim 11, wherein the one or more liquid cooled optical mounts are for laser rods and provide for thermal pointing stability of the optical components.
